(19) United States
(12) Patent Application Publication
(10) Pub. No.: US 2019/0174386 A1
(43) Pub. Date: Jun. 6, 2019

(54) HANDOVER PROCEDURE

(71) Applicant: Telefonaktiebolaget LM Ericsson (publ), Stockholm (SE)

(72) Inventors: Peter Ramle, Mölnlycke (SE); Josefin Karlsson, Torslanda (SE); Lasse Olsson, Träslövsläge (SE)

(21) Appl. No.: 16/322,315

(22) PCT Filed: Aug. 29, 2017
(86) PCT No.: PCT/EP2017/071626

§ 371 Date: Jan. 31, 2019

Related U.S. Application Data
(60) Provisional application No. 62/380,716, filed on Aug. 29, 2016.

(51) Int. Cl. H04W 36/32; H04W 36/00; H04W 36/38

(52) U.S. Cl. CPC H04W 36/32; H04W 36/385; H04W 36/0061

(57) ABSTRACT

Disclosed herein is a method for handover of a User Equipment (UE), performed by a target Next Generation (NG) Core Control Function (CCF) operative in a core network, the method comprising: receiving a request; and sending an indication of a temporary UE identifier, a Tracking Area Identity (TAI) list, and/or an allowed area. Also, for implementing the method, disclosed herein are corresponding control plane NG CCF, UE, computer program, and computer program products.

### TECHNICAL FIELD

Described herein is a method for handover, a control plane next generation core control function, a user equipment, a computer program, and a computer program product thereof.

### BACKGROUND

In 3GPP SA2 there is a WI study, FS_NextGen, which study the 5G mobile network. The 3GPP progress so far is very premature. The architecture is still to be defined.

In 3GPP TR 23.799 v0.7.0 (2016 August) clause 4.1 “High level Architecture Requirements” it is stated:

“The architecture of the “Next Gen” network shall

1 Support the new RAT(s), the Evolved E-UTRA, and non-3GPP access types. GERAN and UTRAN are not supported:

a) As part of non- 3GPP access types, WLAN access (including “untrusted WLAN” according to the meaning defined in pre Rel. 14 for the term “untrusted”) and Fixed access shall be supported. Support for satellite access is FFS.”

Today there exist an “Initial high level view” of the architecture included into TR 23.799 v0.7.0 (2016 August) clause 4.2.1, see FIG. 1.

A reference architecture option is stated in TR 23.799 v0.7.0 (2016 August) clause 7.3.2. FIG. 2 shows figure 7.3.2-1 of the clause and depicts the non-roaming architecture functional view. FIG. 3 shows figure 7.3.2-2 of the clause and depicts the non-roaming architecture for UEs concurrently accessing a local and a central data network using multiple PDU Sessions, applying non-roaming reference architecture for concurrent access to local and central data networks (multiple PDU session option). FIG. 4 shows figure 7.3.2-3 of the clause and depicts the non-roaming architecture in case concurrent access to local and central data networks is provided within a single PDU session, applying non-roaming reference architecture for concurrent access to local and central data networks (single PDU session option). FIG. 5 shows figure 7.3.2-4 of the clause and depicts the roaming architecture in case of home routed scenario, i.e. roaming reference architecture—home routed scenario. FIG. 6 shows figure 7.3.2-5 of the clause and depicts the roaming architecture in case of local break out scenario, i.e. roaming reference architecture—local breakout scenario.

The 5G Reference Architecture consist of the following functions:
NG Subscriber Data Management (NG SDM)
NG Policy Control function (NG PCF)
NG Core Control functions (NG CCFs)
NG Core User plane function (NG UPF)
NG RAN
NG UE
Data network, e.g. operator services, Internet access or 3rd party services.

The following is a high level split of functionality between the control plane and the user plane.

The NG Core Control functions include the following functionality:
Termination of RAN CP interface
Termination of NAS
Access Authentication
NAS Ciphering and Integrity protection
Mobility management
Session Management
UE IP address allocation & management (incl optional Authorization)
Selection of UP function
Termination of interfaces towards Policy control and Charging functions
Policy & Charging rules handling, incl control part of enforcement and QoS
Lawful intercept (CP and interface to LI System)

Not all of the CCF functions are required to be supported in an instance of CCFs of a network slice.

The NG Core User plane function includes the following functionality:
Anchor point for Intra-/Inter-RAT mobility (when applicable)
External PDU session point of interconnect (e.g. IP).
Packet routing & forwarding
QoS handling for User plane
Packet inspection and Policy rule enforcement
Lawful intercept (UP collection)
Traffic accounting and reporting

Not all of the UPF functions are required to be supported in an instance of user plane function of a network slice.

The NG Policy function includes the following functionality:
Supports unified policy framework to govern network behaviour.
Provides policy rules to control plane function(s) to enforce them.

The need for an interface between NG Policy Function and SDM is FFS.

The 5G Reference Architecture contain the following reference points:

NG1: Reference point between the UE and the NG Core Control plane function.

NG2: Reference point between the RAN and the NG Core Control plane function.

NG3: Reference point between the RAN and the NG Core User plane function.

NG4: Reference point between the NG Core Control plane function and the NG Core User plane function.

NG5: Reference point between the NG Policy Control functions and an Application Function.

NG6: Reference point between the NG Core User plane function and a Data Network (DN).

NG6*: Reference point between an NG Core User plane function and a local Data Network (when concurrent access to both a local and central data network is provided for one PDU session with a single IP address/prefix).

Details of NG6* mechanisms are beyond the scope of 3GPP.

NG7: Reference point between the NG Core Control plane function and the NG Policy Control function.

NG8: Reference point between the NG Core Control plane function and the NG Subscriber Data Management.

NG9: Reference point between two NG Core User plane functions.

NG7r: Reference point between the Visiting NG Policy Control function (V-PCF) and the Home NG Policy Control function (H-PCF).

NG-RC: Reference point between the Visiting NG Core Control plane function (V-CCFs) and the Home NG Core Control plane function (H-CCFs).

Whether additional reference points between NG Core User plane functions (UPFs) need to be defined for other user-plane scenarios or for further study (FFS).

### SUMMARY

An object of embodiments presented herein is to enable reduced complexity for handover of a user equipment.

According to a first aspect there is presented a method for handover of a user equipment (UE). The method is performed by a target control plane next generation (NG) core control function (NG CCF) operative in a core network. The method comprises receiving a request, and sending an indication of a temporary UE identifier and/or a TAI list and/or an allowed area.

By the presented method the TAU procedure can be excluded as a part of the handover procedure.

The request may comprise sending a forward relocation request from a source NG CCF, and the sending may comprise sending a forward relocation response to the source NG CCF including the indication.

According to a second aspect there is presented a method for handover of a user equipment (UE). The method is performed by a control plane next generation (NG) core control function (NG CCF) operative in a core network. The method comprises receiving a path switch request from a target radio access network (RAN) and sending a path switch request ack to the target RAN, including a GUTI reallocation command message, in order to provide the UE with a new temporary UE identifier, TA, TA list and/or allowed area. The allowed area may e.gg be some TAs, cells or any other geographical information.

According to a third aspect there is presented a method for handover of a user equipment (UE). The method is performed by a target radio access network (RAN) operative in a network. The method comprises receiving a path switch request ack from a NG CCF, and sending a DL information transfer to the UE, including a GUTI reallocation command, in order to provide the UE with a new temporary UE identifier, TA, TA list and allowed area.

According to a fourth aspect there is presented a method for handover of a user equipment (UE). The method is performed by the UE operative in a network. The method comprises receiving a DL information transfer from a target RAN, and sending a GUTI reallocation complete to a NG CCF.

According to a fifth aspect there is presented a method for handover of a user equipment (UE). The method is performed by the UE and comprises receiving a handover command including a temporary UE identifier, TA, TA list and/or allowed area, and sending a handover confirmation including a TAU complete message.

According to a sixth aspect there is presented a method for handover of a user equipment (UE). The method is performed by a source control plane next generation (NG) core control function (NG CCF) operative in a core network. The method comprises receiving a target global unique temporary identity (such as GUTI), TA, TA list and/or allowed area from a target NG CCF, and sending a handover command including the target temporary UE identifier (such as GUTI), TA, TA list and allowed area to a source radio access network (RAN).

According to a seventh aspect there is presented a method for handover of a user equipment (UE). The method is performed by a source radio access network (RAN) operative in a network. The method comprises receiving a handover command including a target global temporary identity (such as GUTI), TA, TA list and/or allowed area from a source control plane next generation (NG) core control function (NG CCF), and sending a handover command including the target global UE temporary identity (such as GUTI), TA, TA list and allowed area to a UE.

According to an eighth aspect there is presented a method for handover of a user equipment (UE). The method is performed by a target radio access network (RAN) operative in a network. The method comprises receiving a handover confirm including an indication of tracking area update (TAU) complete (or a registration complete) from a UE, and sending a handover notify including the indication of TAU complete (or registration complete) to a target control plane next generation (NG) core control function (NG CCF).

According to a ninth aspect there is presented a target control plane next generation (NG) core control function (NG CCF) operative in a core network for handover of a user equipment (UE). The NG CCF comprises a processor, and a computer program product storing instructions that, when executed by the processor, causes the NG CCF to receive a forward relocation request from a source NG CCF, and to send a forward relocation response to the source NG CCF, indicating a temporary UE identifier, a TAI list and/or allowed area.

According to a tenth aspect there is presented a control plane next generation (NG) core control function (NG CCF) operative in a core network for handover of a user equipment (UE). The NG CCF comprises a processor, and a computer program product storing instructions that, when executed by the processor, causes the NG CCF to receive a path switch request from a target radio access network (RAN), and to send a path switch request ack to the target RAN, including the temporary UE identifier, TA, TAI list and/or allowed area.

According to an eleventh aspect there is presented a target radio access network (RAN) operative in a network for handover of a user equipment (UE). The target RAN comprises a processor, and a computer program product storing instructions that, when executed by the processor, causes the target RAN to receive a path switch request ack from a NG CCF, and to send a DL information transfer to the UE, including a GUTI reallocation command, GUTI, TA, TAI list and/or allowed area.

According to a twelfth aspect there is presented a user equipment (UE) for handover thereof. The UE comprises a processor, and a computer program product storing instructions that, when executed by the processor, causes the UE to receive a DL information transfer, GUTI, TA, TAI list and/or allowed area, from a target RAN, and to send a GUTI reallocation complete to a NG CCF.

According to a thirteenth aspect there is presented a UE for handover thereof. The UE comprises a processor and a computer program product storing instructions that, when executed by the processor, causes the UE to receive a handover command including a temporary UE identifier, TA, TAI list and/or allowed area, information, and to send a handover confirmation including a TAU complete message.

According to a fourteenth aspect there is presented a source control plane next generation (NG) core control function (NG CCF) operative in a core network for handover of a user equipment (UE). The source NG CCF comprises a processor, and a computer program product storing instructions that, when executed by the processor, causes the source NG CCF to receive a target global unique temporary identity (GUTI), TA, TAI-list and/or allowed area, from a target NG CCF, and send a handover command including the target GUTI, TA, TAI-list and/or allowed area, to a source radio access network (RAN).

According to a fifteenth aspect there is presented a source radio access network (RAN) operative in a network for handover of a user equipment (UE). The source RAN comprises a processor, and a computer program product storing instructions that, when executed by the processor, causes the source RAN to receive a handover command including a target global unique temporary identity (GUTI), TA, TAI-list and/or allowed area, from a source control plane next generation (NG) core control function (NG CCF), and to send a handover command including the target GUTI, TA, TAI-list and/or allowed area, to a UE.

According to a sixteenth aspect there is presented a target radio access network (RAN) operative in a network for handover of a user equipment (UE). The target RAN comprises a processor, and a computer program product storing instructions that, when executed by the processor, causes the target RAN to receive a handover confirm including an indication of tracking area update (TAU) complete from a UE, and to send a handover notify including the indication of TAU complete to a target control plane next generation (NG) core control function (NG CCF).

According to a seventeenth aspect there is presented a target control plane next generation (NG) core control function (NG CCF) operative in a core network for handover of a user equipment (UE). The target NG CCF comprises a communication manager for receiving a forward relocation request from a source NG CCF, and for sending a a forward relocation response to the source NG CCF, indicating temporary user equipment (UE) identifier, TAI list and/or allowed area.

According to an eighteenth aspect there is presented a control plane next generation (NG) core control function (NG CCF) operative in a core network for handover of a user equipment (UE). The NG CCF comprises a communication manager for receiving a path switch request from a target radio access network (RAN), and for sending a path switch request ack to the target RAN, including a GUTI reallocation command message, GUTI, TA, TAI list and/or allowed area.

According to a nineteenth aspect there is presented a target radio access network (RAN) operative in a network for handover of a user equipment (UE). The target RAN comprises a communication manager for receiving a path switch request ack from a NG CCF, and sending a DL information transfer to the UE, including a GUTI reallocation command, GUTI, TA, TAI list and/or allowed area.

According to a twentieth aspect there is presented a user equipment (UE) for handover thereof. The UE comprises a communication manager for receiving a DL information transfer, GUTI, TA, TAI-list and/or allowed area, from a target RAN, and sending a GUTI reallocation complete to a NG CCF.

According to a twenty-first aspect there is presented a user equipment (UE) for handover thereof. The UE comprises a communication manager for receiving a handover command including a temporary user equipment (UE) identifier, TA, TAI list and/or allowed area, and after handover to a target cell for sending a handover confirmation.

According to a twenty-second aspect there is presented a source control plane next generation (NG) core control function (NG CCF) operative in a core network for handover of a user equipment (UE). The source NG CCF comprises a communication manager for receiving a target global unique temporary identity (GUTI) from a target NG CCF, and for sending a handover command including the target GUTI, TA, TAI list and/or allowed area, to a source radio access network (RAN).

According to a twenty-third aspect there is presented a source radio access network (RAN) operative in a network for handover of a user equipment (UE). The source RAN comprises a communication manager for receiving a handover command including a target global unique temporary identity (GUTI), TA, TAI list and/or allowed area, from a source control plane next generation (NG) core control function (NG CCF), and for sending a handover command including the target GUTI, TA, TAI-list and/or allowed area, to a UE.

According to a twenty-fourth aspect there is presented a target radio access network (RAN) user equipment (UE) for handover thereof. The target RAN comprises a communication manager for receiving a handover confirm including an indication of tracking area update (TAU) complete from a UE, and for sending a handover notify including the indication of TAU complete to a target control plane next generation (NG) core control function (NG CCF).

According to a twenty-fifth aspect there is presented a computer program for handover of a user equipment (UE). The computer program comprises computer program code which, when run on a target control plane next generation (NG) core control function (NG CCF) operative in a core network, causes the target NG CCF to receive a forward relocation request from a source NG CCF, and to send a forward relocation response to the source NG CCF, indicating a temporary user equipment (UE) identifier, TA, TAI list and/or allowed area.

According to a twenty-sixth aspect there is presented a computer program for handover of a user equipment (UE). The computer program comprises computer program code which, when run on a control plane next generation (NG) core control function (NG CCF) operative in a core network, causes the NG CCF to receivie a path switch request from a target radio access network (RAN), and to send a path switch request ack to the target RAN, including a GUTI reallocation command message, TA, TAI list and/or allowed area.

According to a twenty-seventh aspect there is presented a computer program for handover of a user equipment (UE). The computer program comprises computer program code which, when run on a target radio access network (RAN) operative in a network, causes the target RAN to receive a path switch request ack from a NG CCF, and to send a DL information transfer to the UE, including a GUTI reallocation command, TA, TAI list and/or allowed area.

According to a twenty-eighth aspect there is presented a computer program for handover of a user equipment (UE). The computer program comprising computer program code which, when run on the UE, causes the UE to receive a DL information transfer from a target RAN, and to send a GUTI reallocation complete to a NG CCF.

According to a twenty-ninth aspect there is presented a computer program for handover of a user equipment (UE). The computer program comprises computer program code which, when run on the UE, causes the UE to receive a handover command including a temporary user equipment (UE) identifier, TA, TAI list and/or allowed area, and to send a handover confirmation. The handover confirmation is sent after handover to a target cell.

According to a thirtieth aspect there is presented a computer program for handover of a user equipment (UE). The computer program comprises computer program code which, when run on a source control plane next generation (NG) core control function (NG CCF) operative in a core network, causes the source NG CFF to receive a target global unique temporary identity (GUTI), TAI list and/or allowed area, from a target NG CCF, and to send a handover command including the target GUTI, TA, TAI list and/or allowed area, to a source radio access network (RAN).

According to a thirty-first aspect there is presented a computer program for handover of a user equipment (UE). The computer program comprises computer program code which, when run on a source radio access network

(RAN) operative in a network, causes the source RAN to receive a handover command including a target global unique temporary identity (GUTI), TA, TAI list and/or allowed area, from a source control plane next generation (NG) core control function (NG CCF), and to send a handover command including the target GUTI, TA, TAI list and/or allowed are, to a UE.

According to a thirty-second aspect there is presented a computer program for handover of a user equipment (UE). The computer program comprises computer program code which, when run on a target radio access network (RAN) operative in a network, causes the target RAN to receive a handover confirm including an indication of tracking area update (TAU) complete from a UE, and to send a handover notify including the indication of TAU complete to a target control plane next generation (NG) core control function (NG CCF).

According to a thirty-third aspect there is presented a computer program product. The computer program product comprises a computer program and a computer readable storage means on which the computer program is stored.

Generally, all terms used herein are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Certain embodiments are now described, by way of example, with reference to the accompanying drawings, in which:

FIG. 1 is an initial high level view;

FIG. 2 is figure 7.3.2-1 of 3GPP TR 23.799 v0.7.0 (2016 August) clause 4.1;

FIG. 3 is figure 7.3.2-2 of 3GPP TR 23.799 v0.7.0 (2016 August) clause 4.1;

FIG. 4 is figure 7.3.2-3 of 3GPP TR 23.799 v0.7.0 (2016 August) clause 4.1;

FIG. 5 is figure 7.3.2-4 of 3GPP TR 23.799 v0.7.0 (2016 August) clause 4.1;

FIG. 6 is figure 7.3.2-5 of 3GPP TR 23.799 v0.7.0 (2016 August) clause 4.1;

FIG. 7 is S1 handover procedure according to TS 23.401 (session parts excluded);

FIG. 8 is X2 handover procedure according to TS 23.401 (session parts excluded);

FIG. 9 is a handover procedure without trailing TAU (session parts exclude);

FIG. 10 is a handover procedure, based on X2 handover procedure according to TS 23.401, without trailing TAU (session parts excluded);

FIG. 11 is a schematic diagram illustrating an environment where embodiments presented herein can be applied;

FIGS. 12-19 are flow charts illustrating methods for embodiments presented herein;

FIGS. 20-21 are schematic diagrams illustrating some components of devices presented herein;

FIGS. 22-23 are schematic diagrams showing functional modules of devices presented herein;

FIG. 24 is block diagrams of a wireless network; and

FIG. 25 is a block diagram of a UE.

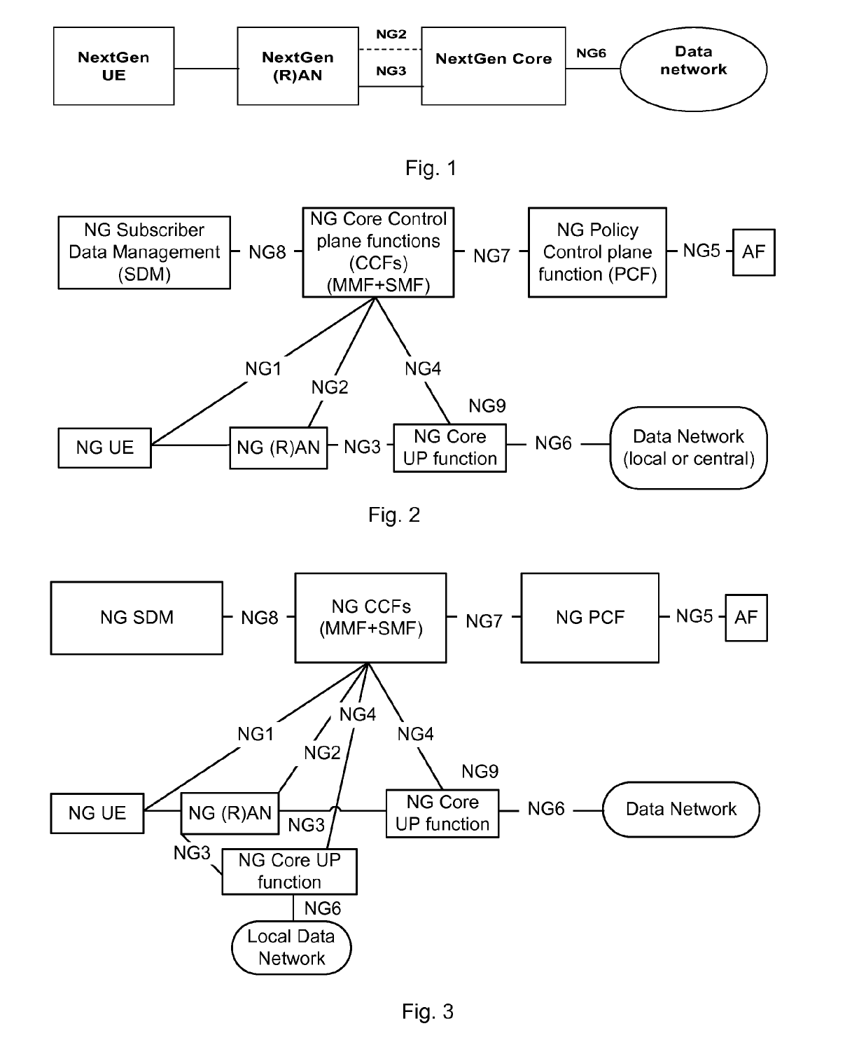

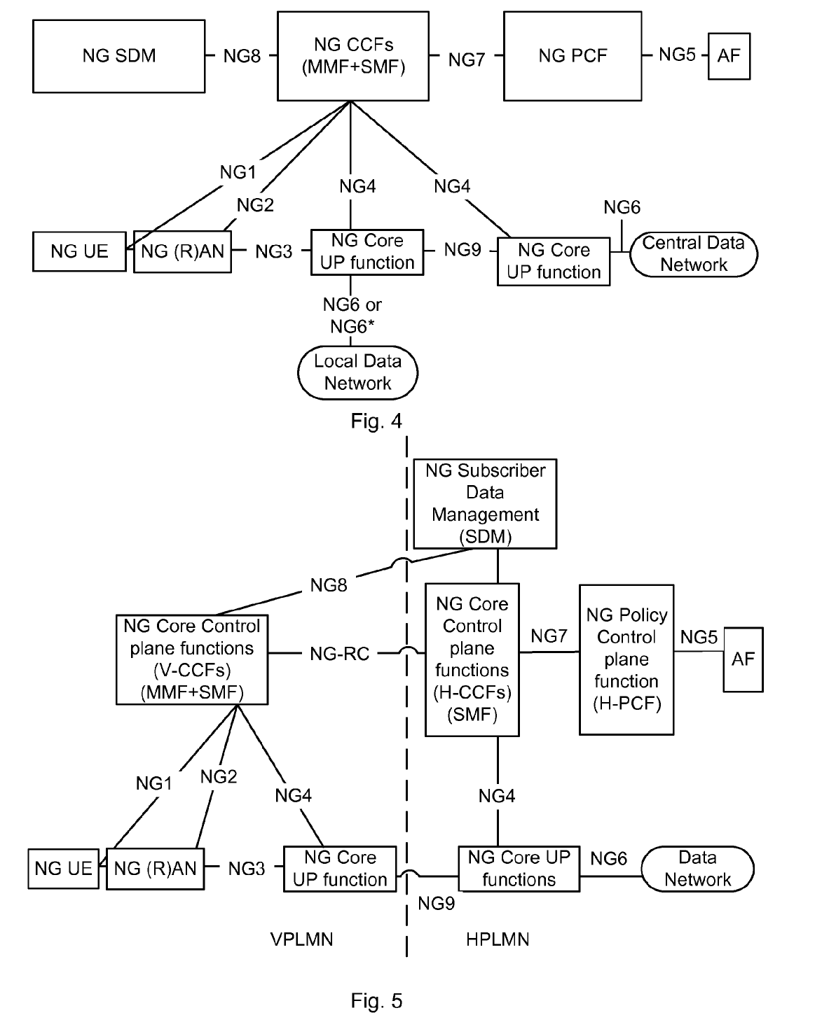

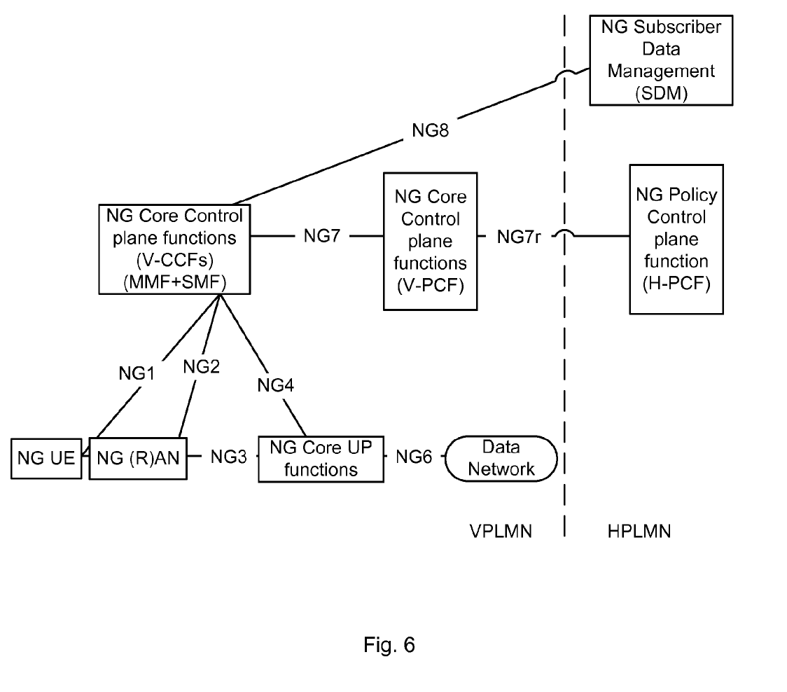

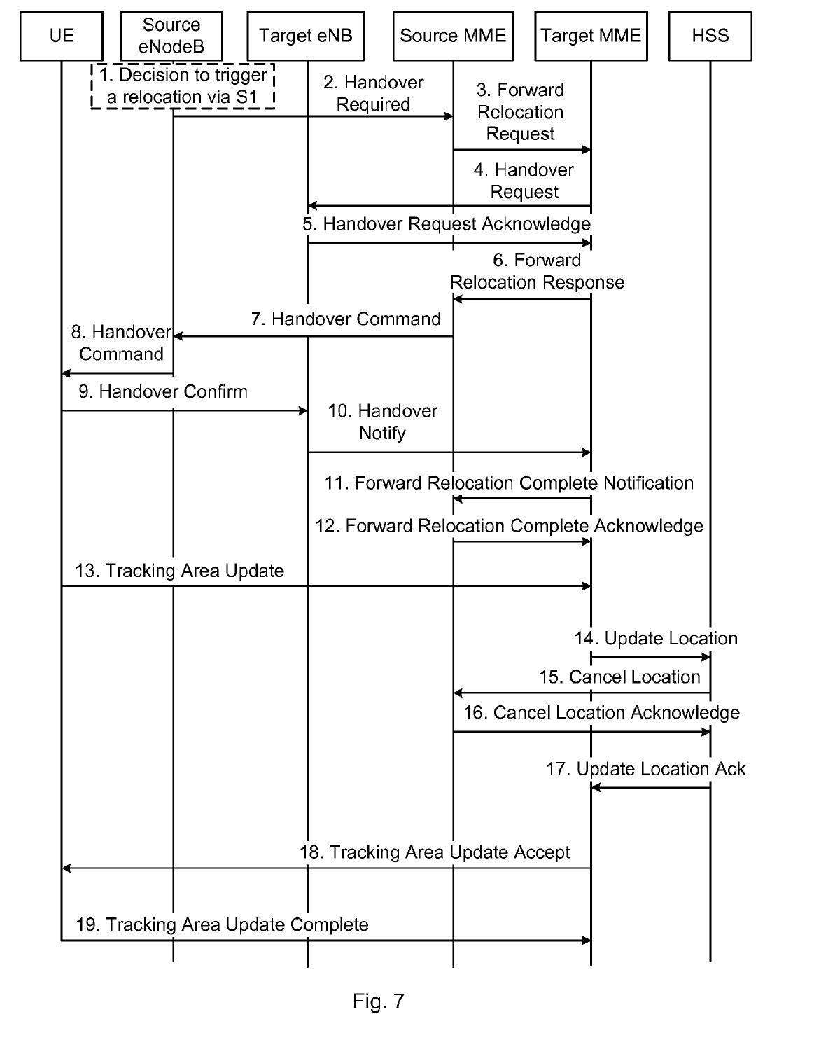

### DETAILED DESCRIPTION

Certain embodiments will now be described more fully hereinafter with reference to the accompanying drawings. The features and benefits disclosed herein may, however, be embodied in many different forms and should not be construed as limited to the embodiments set forth herein; rather, these embodiments are provided by way of example so that this disclosure will help convey the scope of the invention to those skilled in the art. Like numbers refer to like elements throughout the description.

Regardless of the number of CCFs, there is only one NAS interface instance between the UE and the CN, terminated at one of the CCFs that implements at least access authentication and mobility management.

NG Policy Control Plane function (NG PCF) is a similar function as PCRF used for GERAN, UTRAN and E-UTRAN.

NG Core Control Plane function (NG CCF) represents the control plane of the Core Network (CN) and has the similar functionality as the Mobility Management Entity (MME), and also the control plane of the Serving Gateway (S-GW) and the Packet Data Network (PDN) Gateway (P-GW) in E-UTRAN.

Handover as described in 3GPP according to 3GPP TS 23.401.

In 3GPP the handover procedures include a Tracking Area update procedure which is triggered by the UE when a new Tracking Area is detected by the UE. This procedure is executed at the end of the handover procedure.

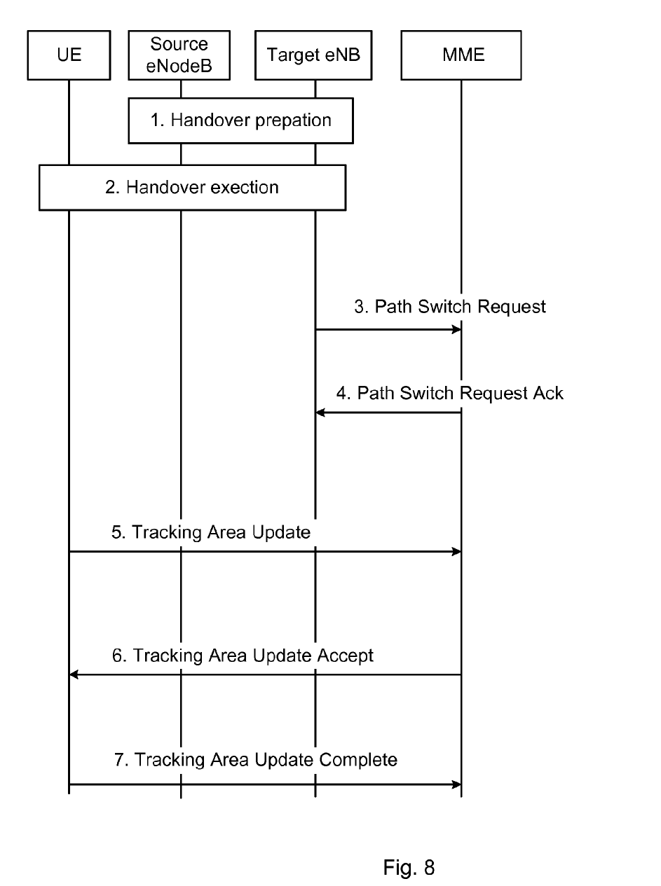

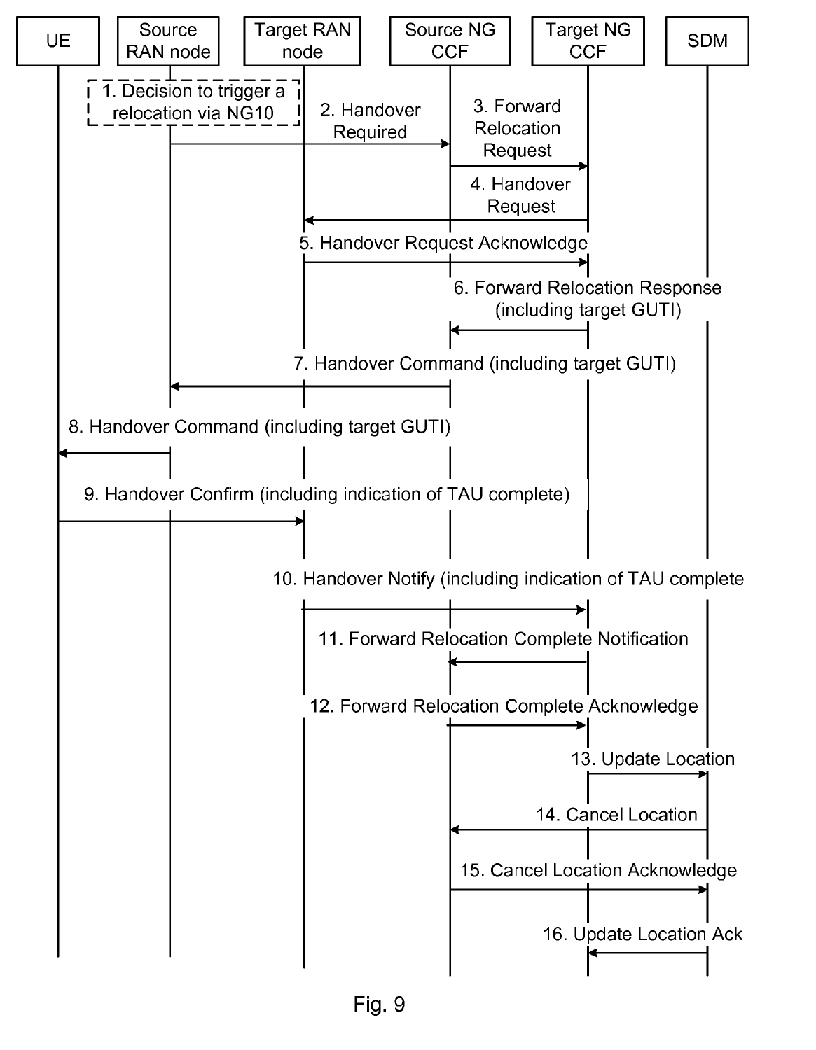

The S1 handover procedure according to TS 23.401 (session parts excluded) is illustrated in FIG. 8. The X2 handover procedure according to TS 23.401 (session parts excluded) is illustrated in FIG. 9 with proposed differences.

In an effort to reduce complexity and for some cases also reduce signalling it has been proposed to combine the legacy Attach and TAU procedures into one new procedure the Registration procedure (see 62/357576, application filed). To further reduce signalling it is proposed to adjust the S1 Handover procedure in such a way as to remove the trailing TAU procedure. Thereby it will be less signalling over the air interface and latency is reduced.

Handover is a time critical procedure as it is a mobility procedure performed when the UE is in Connected mode and therefore it is essential that the UE is handled to target side by the network as soon as possible.

The trailing Tracking Area Update procedure is proposed to be removed from the handover procedures. Instead the temporary UE identifier (e.g. GUTI) is reallocated (and possibly also a change of TAI list) by the (target) network in previous handover steps. The information handling is dependent of type of handover procedure:
“S1 based” handover (NG2 based handover): The temporary UE identity is allocated and sent from the (target) CN via source network to the UE in existing signalling. A UE response/acknowledge is also sent in existing signalling to the CN.
“X2 based handover”: The temporary UE identity is allocated and sent from the CN to the UE through RAN in existing signalling. UE respond back to the CN through RAN.

Both for “S1 based” handover and “X2 based handover” the UE is provided with a new tracking area (TA) and other related area information. The new TA may be sent directly from a source core network (CN), i.e. does not need to be retrieved from a target CN node.

The benefit with this solution is that the handover procedures includes less signalling and thus will result in shorter time to execute, fewer corner cases and finally saves UE battery resources (less OTA signalling).

The handover procedures similar as S1 handover and X2 handover used in E-UTRAN are proposed to reduce the NAS messages of the TAU procedure as part of the handover procedure.

The Handover procedure disclosed herein may be applicable e.g. for new RAT (i.e. 5G), evolved E-UTRA, UTRAN and GERAN.

FIG. 9 illustrates NG2 based handover (“S1 based handover” in 5G) (similar as S1 based handover for E-UTRAN).

Sequence description highlighting the differences compared to legacy handover. Session related aspects are excluded for simplicity reasons.

Steps 1-5: Are performed similarly as in legacy S1 Handover procedure.

Step 6: Target NG CCF allocates a temporary UE identifier (e.g. GUTI), TAI list and allowed area to be used in target network and includes it in the response to the source NG CCF.

Steps 7-8: Target UE temporary identifier is transferred to the UE (and a possible TAI-list).

Step 9: The UE includes an indication that the target UE temporary identifier is accepted (i.e. a complete indication).

Step 10: The complete indication is forwarded from target RAN node to target NG CCF.

Steps 11-12: Are performed similarly as in legacy S1 Handover procedure.

Step 13: As a consequence of receiving the complete indication in step 10 the target NG CCF executes the Location Update procedure. If the subscription data in Update Location Ack is changed a standalone HSS/SDM initiated modification procedure is triggered separately from the Handover procedure.

As an alternative to steps 6-8 above an indication of Tracking Area Update Accept (Registration Accept) could be sent from the CN to the UE. Step 9 and could e.g. include Tracking Area Update Complete or Registration Complete.

The TAU request, TAU Accept and TAU Complete messages are by this unnecessary and therefore excluded.

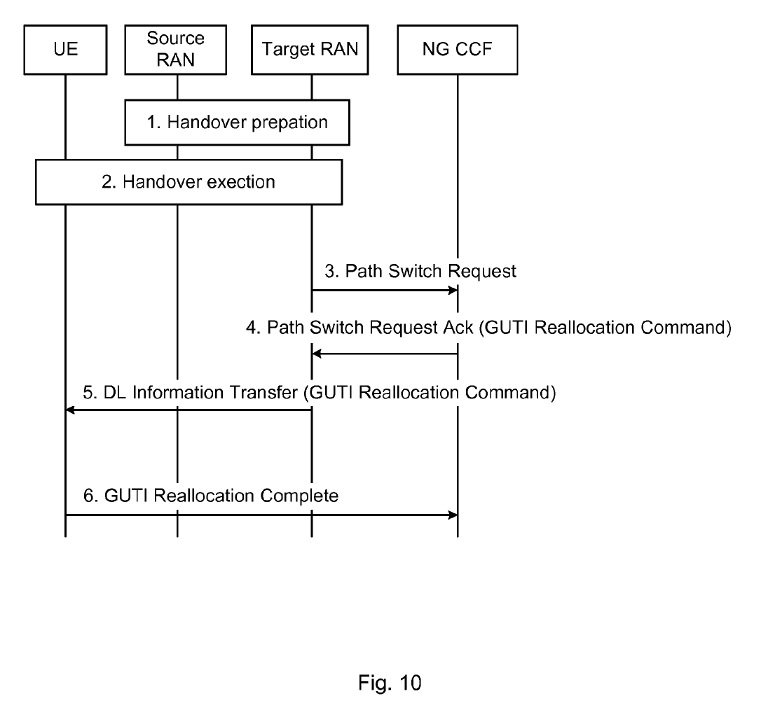

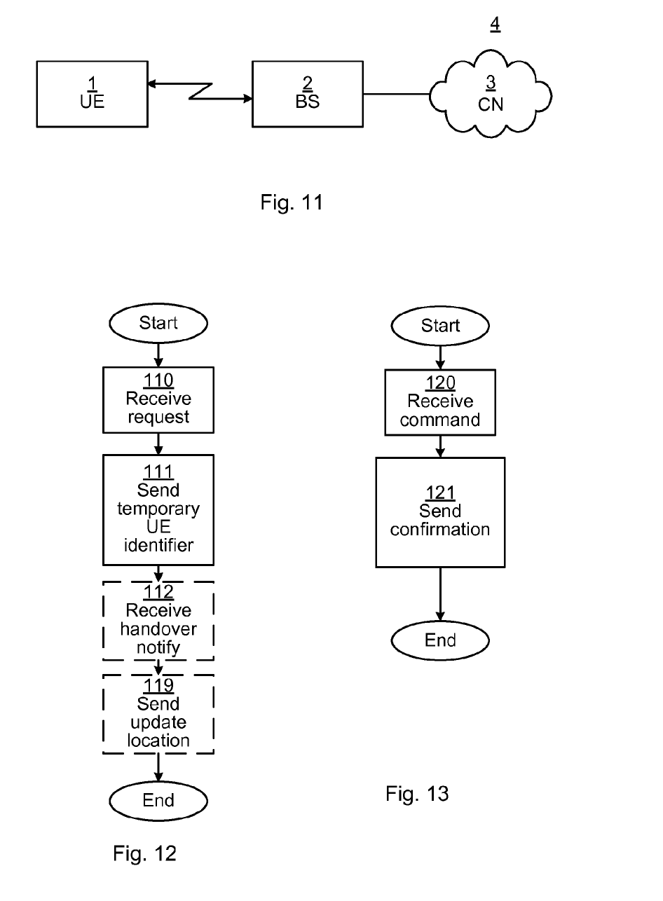

FIG. 10 illustrates “X2 based handover” in 5G.

Sequence description highlighting the differences compared to legacy handover. Session related aspects are excluded for simplicity reasons.

Steps 1-3: Are performed similarly as in legacy X2 Handover procedure.

Step 4: NG CCF may allocate a temporary UE identifier (e.g. GUTI), TAI list and allowed area to be used in target network and include it in a NAS message which is included into the message to the RAN.

Step 5: Target RAN transparently forwards the received NAS message (e.g. GUTI Reallocation Command) to the UE.

Step 6: The UE responds that the target UE temporary identifier is accepted (e.g. GUTI Reallocation Complete).

As an alternative to GUTI Reallocation procedure an indication of Tracking Area Update Accept (Registration Accept) could be sent from the CN to the UE and a related indication of Tracking Area Update Complete (Registration Complete) could be sent as a response from the UE to the CN.

The TAU request, TAU Accept and TAU Complete messages are by this unnecessary and therefore excluded.

A method, according to an embodiment, for handover of a user equipment (UE), performed by a control plane next generation (NG) core control function (NG CCF) operative in a core network is presented with reference to FIG. 12. The method comprises receiving 110 a forward relocation request from a source NG CCF, and sending 111 a forward relocation response to the source NG CCF, indicating a temporary UE identifier, TAI list and/or allowed area.

The temporary UE identifier may be a target global unique temporary identity (GUTI).

The method may further comprise receiving 112 a handover notify from a target radio access network (RAN), indicating that the temporary UE identifier is accepted by the UE. The handover notify may include an indication of tracking area update (TAU) complete.

The temporary UE identifier may be an indication of TAU accept (registration accept). The method may further comprise receiving a handover notify from a target radio access network including a TAU complete or registration complete.

The method may further comprise sending an update location to a subscriber data management (SDM).

A method, according to an embodiment, for handover of a UE is presented with reference to FIG. 13. The method is performed by the UE, and the method comprises receiving 120 a handover command including a temporary UE identifier, and sending 121 a handover confirmation.

The handover command may be received from a source RAN, and the handover confirmation is sent to a target RAN node.

The handover command may include a target GUTI and/or a new TA and/or a TAI-list.

The handover confirmation may include an indication of TAU complete.

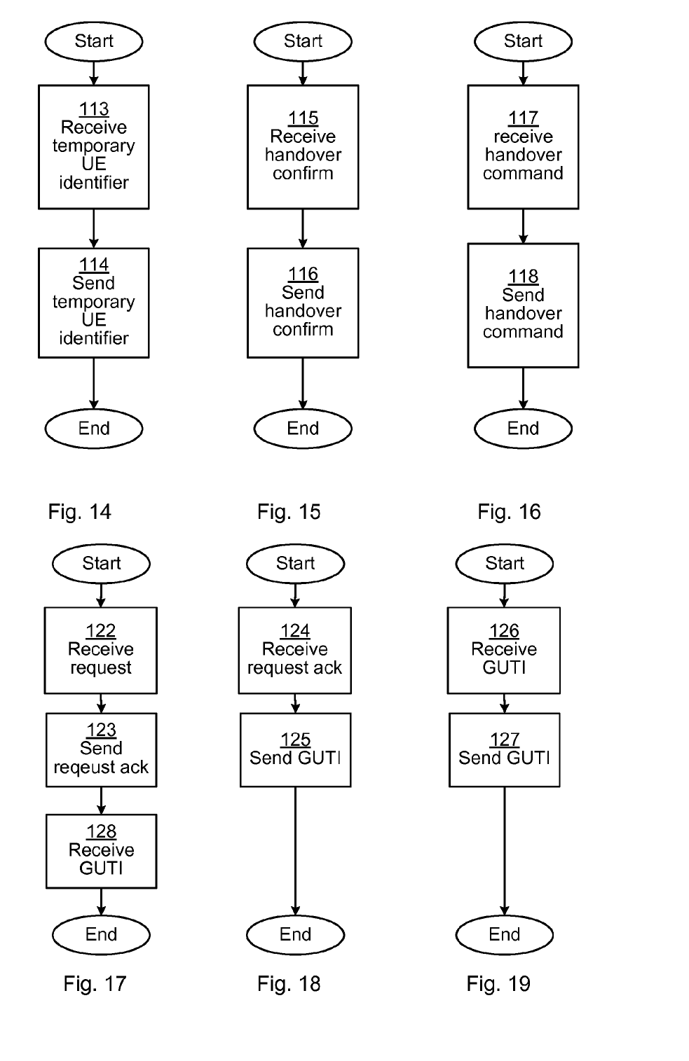

A method, according to an embodiment, for handover of a UE is presented with reference to FIG. 14. The method is performed by a source NG CCF operative in a core network, and the method comprises receiving 113 a target GUTI, TAI list and allowed area from a target NG CCF, and sending 114 a handover command including the target GUTI, TA, TAI list and allowed area to a source RAN node.

A method, according to an embodiment, for handover of a UE is presented with reference to FIG. 16. The method is performed by a source RAN node operative in a network, and the method comprises receiving 117 a handover command including a target GUTI, TA, TAI list and allowed area from a source NG CCF, and sending 118 a handover command including the target GUTI, TA, TAI list and allowed area to a UE.

A method, according to an embodiment, for handover of a UE us presented with reference to FIG. 15. The method is performed by a target RAN node operative in a network, and the method comprises receiving 115 a handover confirm including an indication of TAU complete from a UE, and sending 116 a handover notify including the indication of TAU complete to a target NG CCF.

A method, according to an embodiment, for handover of a UE is presented with reference to FIG. 17. The method is performed by a NG CCF operative in a core network, and the method comprises receiving 122 a path switch request from a target RAN, and sending 123 a path switch request ack to the target RAN, including a GUTI reallocation command message.

The method may further comprise receiving 128 a GUTI reallocation complete message from an UE.

A method, according to an embodiment, for handover of a UE is presented with reference to FIG. 18. The method is performed by a target RAN operative in a network, and the method comprises receiving 124 a path switch request ack from a NG CCF, and sending 125 a DL information transfer to the UE, including a GUTI reallocation command.

A method, according to an embodiment, for handover of a UE is presented with reference to FIG. 19. The method is performed by the UE operative in a network, and the method comprises receiving 126 a DL information transfer from a target RAN, and sending 127 a GUTI reallocation complete to a NG CCF.

A target control plane next generation (NG) core control function (NG CCF) operative in a core network, according to an embodiment, for handover of a user equipment (UE) is presented with reference to FIG. 21. The NG CCF comprises a processor 10, and a computer program product 12, 13 storing instructions that, when executed by the processor, causes the NG CCF to receive 110 a forward relocation request from a source NG CCF, and to send 111 a forward relocation response to the source NG CCF, indicating a temporary UE identifier, TAI list and allowed area.

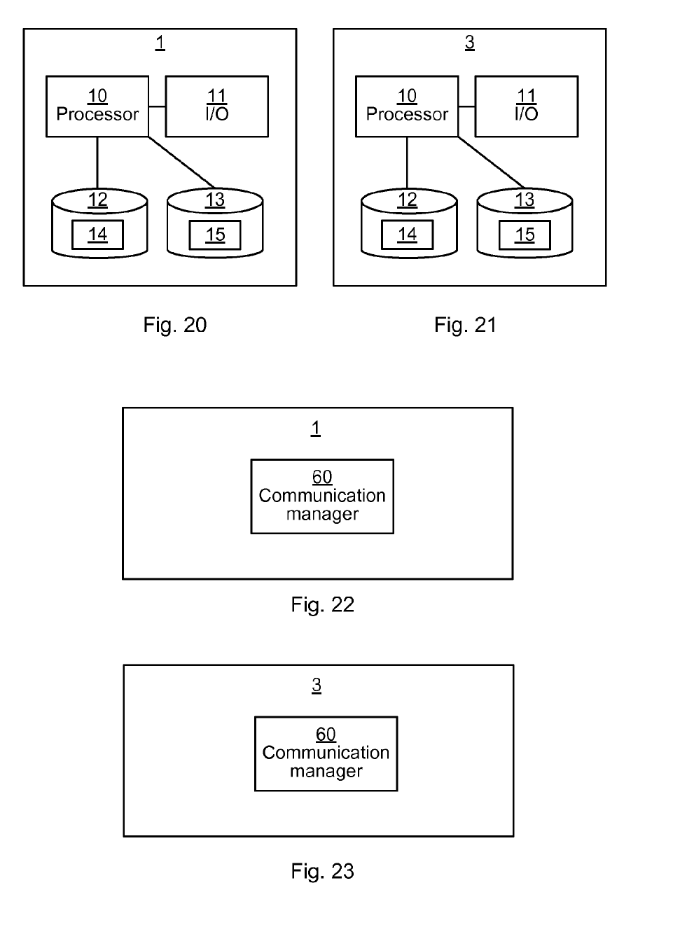

A UE, according to an embodiment, for handover thereof is presented with reference to FIG. 20. The UE comprises a processor 10, and a computer program product 12, 13 storing instructions that, when executed by the processor, causes the UE to receive 120 a handover command including a temporary UE identifier, TA, TAI list and allowed area, and to send 121 a handover confirmation.

A source NG CCF operative in a core network, according to an embodiment, for handover of a UE is presented with reference to FIG. 21. The source NG CCF comprises a processor 10, and a computer program product 12, 13 storing instructions that, when executed by the processor, causes the source NG CCF to receive a target GUTI, TAI list and allowed area, from a target NG CCF, and to send a handover command including the target GUTI, TA, TAI list and allowed area to a source RAN node.

A source RAN operative in a network, according to an embodiment, for handover of a UE is presented with reference to FIG. 21. The source RAN comprises a processor 10, and a computer program product 12, 13 storing instructions that, when executed by the processor, causes the source RAN to receive a handover command including a target GUTI, TA, TAI list and allowed area from a source NG CCF, and to send a handover command including the target GUTI, TA, TAI list and allowed area, to a UE.

A target RAN operative in a network, according to an embodiment, for handover of a UE is presented with reference to FIG. 21. The target RAN comprises a processor 10, and a computer program product 12, 13 storing instructions that, when executed by the processor, causes the target RAN to receive a handover confirm including an indication of TAU complete from a UE, and to send a handover notify including the indication of TAU complete to a target NG CCF.

A NG CCF operative in a core network, according to an embodiment, for handover of a UE is presented with reference to FIG. 21. The NG CCF comprises a processor 10, and a computer program product 12, 13 storing instructions that, when executed by the processor, causes the NG CCF to receive a path switch request from a target RAN, and to send a path switch request ack to the target RAN, including the temporary UE identifier, TA, TAI list and allowed area.

A target RAN operative in a network, according to an embodiment, for handover of a UE is presented with reference to FIG. 21. The target RAN comprises a processor 10, and a computer program product 12, 13 storing instructions that, when executed by the processor, causes the target RAN to receive a path switch request ack from a NG CCF, and to send a DL information transfer to the UE, including a GUTI reallocation command.

A UE, according to an embodiment, for handover thereof is presented with reference to FIG. 20. The UE comprises a processor 10, and a computer program product 12, 13 storing instructions that, when executed by the processor, causes the UE to receive a DL information transfer from a target RAN, and to send a GUTI reallocation complete to a NG CCF.

A control plane next generation (NG) core control function (NG CCF) operative in a core network, according to an embodiment, for handover of a user equipment (UE) is presented with reference to FIG. 23. The NG CCF comprises a communication manager 60 for receiving 110 a forward relocation request from a source NG CCF, and for sending 111 a forward relocation response to the source NG CCF, indicating a temporary UE identifier, TAI list and allowed area.

A UE, according to an embodiment, for handover thereof is presented with reference to FIG. 22. The UE comprises a communication manager 60 for receiving 120 a handover command including a temporary user equipment UE identifier, TA, TAI list and allowed area, and for sending 121 a handover confirmation.

A NG CCF operative in a core network, according to an embodiment, for handover of a UE is presented with reference to FIG. 23. The NG CCF comprises a communication manager 60 for receiving 122 a path switch request from a target RAN, and for sending 123 a path switch request ack to the target RAN, including a GUTI reallocation command message.

A target RAN operative in a network, according to an embodiment, for 3o handover of a UE is presented with reference to FIG. 23. The target RAN comprises a communication manager 60 for receiving 124 a path switch request ack from a NG CCF, and for sending 125 a DL information transfer to the UE, including a GUTI reallocation command, TA, TAI list and allowed area.

A UE, according to an embodiment, for handover thereof is presented with reference to FIG. 23. The UE comprises a communication manager 60 for receiving 126 a DL information transfer from a target RAN, and for sending 127 a GUTI reallocation complete to a NG CCF.

A source NG CCF operative in a core network, according to an embodiment, for handover of a UE is presented with reference to FIG. 23. The source NG CCF comprises a communication manager 60 for receiving 113 a target GUTI, TAI list and allowed area from a target NG CCF, and for sending 114 a handover command including the target GUTI, TA, TAI list and allowed area, to a source RAN node.

A source RAN operative in a network, according to an embodiment, for handover of a UE is presented with reference to FIG. 23. The source RAN comprises a communication manager 60 for receiving 117 a handover command including a target GUTI, TA, TAI list and allowed area, from a source NG CCF, and for sending 118 a handover command including the target GUTI, TA, TAI list and allowed area, to a UE.

A target RAN operative in a network, according to an embodiment, for handover of a UE is presented with reference to FIG. 23. The target RAN comprises a communication manager 60 for receiving 115 a handover confirm including an indication of TAU complete from a UE, and for sending 116 a handover notify including the indication of TAU complete to a target NG CCF.

A computer program 14, 15, according to an embodiment, for handover of a UE is presented. The computer program comprises computer program code which, when run on a target NG CCF operative in a core network, causes the NG CCF to receive 110 a forward relocation request from a source NG CCF, and to send 111 a forward relocation response to the source NG CCF, indicating a temporary UE identifier, TAI list and allowed area.

A computer program 14, 15, according to an embodiment, for handover of a UE is presented. The computer program comprises computer program code which, when run on a source NG CCF operative in a core network, causes the source NG CFF to receive 113 a target GUTI, TAI list and allowed area, from a target NG CCF, and to send 114 a handover command including the target GUTI, TA, TAI list and allowed area, to a source RAN node.

A computer program 14, 15, according to an embodiment, for handover of a UE is presented. The computer program comprises computer program code which, when run on a source RAN operative in a network, causes the source RAN to receive 117 a handover command including a target GUTI, TA, TAI list and allowed area, from a source NG CCF, and to send 118 a handover command including the target GUTI, TA, TAI list, and allowed area, to a UE.

A computer program 14, 15, according to an embodiment, for handover of a UE is presented. The computer program comprises computer program code which, when run on a target RAN operative in a network, causes the target RAN to receive 115 a handover confirm including an indication of TAU complete from a UE, and to send 116 a handover notify including the indication of TAU complete to a target NG CCF.

A computer program 14, 15, according to an embodiment, for handover of a UE is presented. The computer program comprises computer program code which, when run on the UE, causes the UE to receive 120 a handover command including a temporary UE identifier, TA, TAI list and allowed area, and to send 121 a handover confirmation.

A computer program 14, 15, according to an embodiment, for handover of a UE is presented. The computer program comprises computer program code which, when run on a NG CCF operative in a core network, causes the NG CCF to receive 122 a path switch request from a target RAN, and to send 123 a path switch request ack to the target RAN, including a GUTI reallocation command message.

A computer program 14, 15, according to an embodiment, for handover of a UE is presented. The computer program comprising computer program code which, when run on a target RAN operative in a network, causes the target RAN to receive 124 a path switch request ack from a NG CCF, and to send 125 a DL information transfer to the UE, including a GUTI reallocation command.

A computer program 14, 15, according to an embodiment, for handover of a UE is presented. The computer program comprises computer program code which, when run on the UE, causes the UE to receive 126 a DL information transfer from a target RAN, and send 127 a GUTI reallocation complete to a NG CCF.

A computer program product 12, 13 comprising a computer program 14, 15 and a computer readable storage means on which the computer program 14, 15 is stored is also presented.

FIG. 20 is a schematic diagram showing some components of the UE 1. A processor 10 may be provided using any combination of one or more of a suitable central processing unit, CPU, multiprocessor, microcontroller, digital signal processor, DSP, application specific integrated circuit etc., capable of executing software instructions of a computer program 14 stored in a memory. The memory can thus be considered to be or form part of the computer program product 12. The processor 10 may be configured to execute methods described herein with reference to FIGS. 12 and 13.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processor 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the UE 1.

The UE 1 may further comprise an input/output, I/O, interface 11 including e.g. a user interface. The UE 1 may further comprise a receiver configured to receive signalling from other nodes, and a transmitter configured to transmit signalling to other nodes (not illustrated). Other components of the UE 1 are omitted in order not to obscure the concepts presented herein.

FIG. 22 is a schematic diagram showing functional blocks of the UE 1. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the methods illustrated in FIGS. 12 and 13, comprising a communication manager unit 60. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The communication manger 60 is for handover. This module corresponds to the receive step 120 and the send step 121 of FIG. 13. This module can e.g. be implemented by the processor 10 of FIG. 20, when running the computer program.

FIG. 21 is a schematic diagram showing some components of the core plane of core network 3. A processor 10 may be provided using any combination of one or more of a suitable central processing unit, CPU, multiprocessor, microcontroller, digital signal processor, DSP, application specific integrated circuit etc., capable of executing software instructions of a computer program 14 stored in a memory. The memory can thus be considered to be or form part of the computer program product 12. The processor 10 may be configured to execute methods described herein with reference to FIGS. 12 and 13.

The memory may be any combination of read and write memory, RAM, and read only memory, ROM. The memory may also comprise persistent storage, which, for example, can be any single one or combination of magnetic memory, optical memory, solid state memory or even remotely mounted memory.

A second computer program product 13 in the form of a data memory may also be provided, e.g. for reading and/or storing data during execution of software instructions in the processor 10. The data memory can be any combination of read and write memory, RAM, and read only memory, ROM, and may also comprise persistent storage, which, for example, can be any single one or combination of magnetic memory, optical memory, solid state memory or even remotely mounted memory. The data memory may e.g. hold other software instructions 15, to improve functionality for the core plane of the core network 3.

The core plane of the core network 3 may further comprise an input/output, I/O, interface 11 including e.g. a user interface. The core plane of the core network 3 may further comprise a receiver configured to receive signalling from other nodes, and a transmitter configured to transmit signalling to other nodes (not illustrated). Other components of the core plane of the core network 3 are omitted in order not to obscure the concepts presented herein.

FIG. 23 is a schematic diagram showing functional blocks of the core plane of the core network 3. The modules may be implemented as only software instructions such as a computer program executing in the cache server or only hardware, such as application specific integrated circuits, field programmable gate arrays, discrete logical components, transceivers, etc. or as a combination thereof. In an alternative embodiment, some of the functional blocks may be implemented by software and other by hardware. The modules correspond to the steps in the methods illustrated in FIGS. 12 and 13, comprising a communication manager unit 60. In the embodiments where one or more of the modules are implemented by a computer program, it shall be understood that these modules do not necessarily correspond to process modules, but can be written as instructions according to a programming language in which they would be implemented, since some programming languages do not typically contain process modules.

The communication manger 60 is handover. This module corresponds to the receive step 110, the send step 111, and the receive step 112 of FIG. 12. This module can e.g. be implemented by the processor 10 of FIG. 21, when running the computer program.

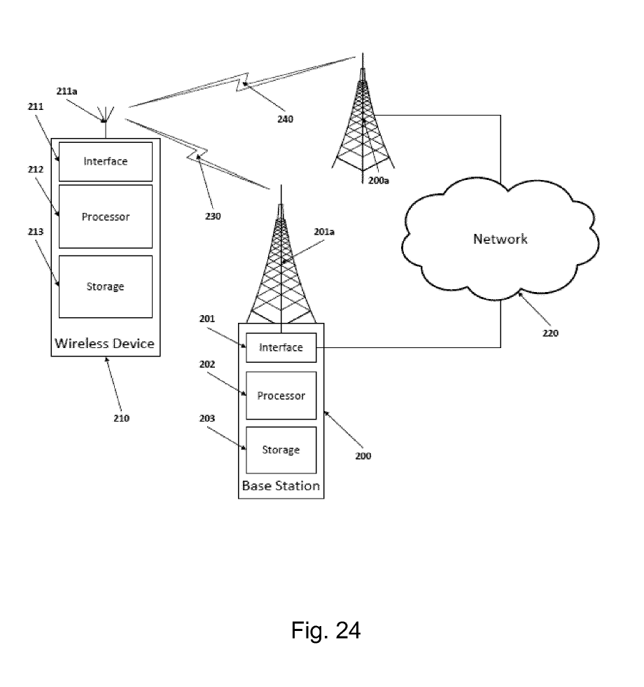

Although the solutions described above may be implemented in any appropriate type of system using any suitable components, particular embodiments of the described solutions may be implemented in a wireless network such as the example wireless communication network illustrated in FIG. 24. In the example embodiment of FIG. 24, the wireless communication network provides communication and other types of services to one or more wireless devices. In the illustrated embodiment, the wireless communication network includes one or more instances of network nodes that facilitate the wireless devices' access to and/or use of the services provided by the wireless communication network. The wireless communication network may further include any additional elements suitable to support communication between wireless devices or between a wireless device and another communication device, such as a landline telephone.

Network 220 may comprise one or more IP networks, public switched telephone networks (PSTNs), packet data networks, optical networks, wide area networks (WANs), local area networks (LANs), wireless local area networks (WLANs), wired networks, wireless networks, metropolitan area networks, and other networks to enable communication between devices.

The wireless communication network may represent any type of communication, telecommunication, data, cellular, and/or radio network or other type of system. In particular embodiments, the wireless communication network may be configured to operate according to specific standards or other types of predefined rules or procedures. Thus, particular embodiments of the wireless communication network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, and/or ZigBee standards.

FIG. 24 illustrates a wireless network comprising a more detailed view of network node 200 and wireless device (WD) 210, in accordance with a particular embodiment. For simplicity, FIG. 2 only depicts network 220, network nodes 200 and 200a, and WD 210. Network node 200 comprises processor 202, storage 203, interface 201, and antenna 201a. Similarly, WD 210 comprises processor 212, storage 213, interface 211 and antenna 211a. These components may work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components that may facilitate or participate in the communication of data and/or signals whether via wired or wireless connections.

As used herein, “network node” refers to equipment capable, configured, arranged and/or operable to communicate directly or indirectly with a wireless device and/or with other equipment in the wireless communication network that enable and/or provide wireless access to the wireless device. Examples of network nodes include, but are not limited to, access points (APs), in particular radio access points. A network node may represent base stations (BSs), such as radio base stations. Particular examples of radio base stations include Node Bs, and evolved Node Bs (eNBs). Base stations may be categorized based on the amount of coverage they provide (or, stated differently, their transmit power level) and may then also be referred to as femto base stations, pico base stations, micro base stations, or macro base stations. “Network node” also includes one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base stations may also be referred to as nodes in a distributed antenna system (DAS).

As a particular non-limiting example, a base station may be a relay node or a relay donor node controlling a relay.

Yet further examples of network nodes include multi-standard radio (MSR) radio equipment such as MSR BSs, network controllers such as radio network controllers (RNCs) or base station controllers (BSCs), base transceiver stations (BTSs), transmission points, transmission nodes, Multi-cell/multicast Coordination Entities (MCEs), core network nodes (e.g., MSCs, MMEs), O&M nodes, OSS nodes, SON nodes, positioning nodes (e.g., E-SMLCs), and/or MDTs. More generally, however, network nodes may represent any suitable device (or group of devices) capable, configured, arranged, and/or operable to enable and/or provide a wireless device access to the wireless communication network or to provide some service to a wireless device that has accessed the wireless communication network.

As used herein, the term “radio node” is used generically to refer both to wireless devices and network nodes, as each is respectively described above.

In FIG. 24, Network node 200 comprises processor 202, storage 203, interface 201, and antenna 201a. These components are depicted as single boxes located within a single larger box. In practice however, a network node may comprise multiple different physical components that make up a single illustrated component (e.g., interface 201 may comprise terminals for coupling wires for a wired connection and a radio transceiver for a wireless connection). As another example, network node 200 may be a virtual network node in which multiple different physically separate components interact to provide the functionality of network node 200 (e.g., processor 202 may comprise three separate processors located in three separate enclosures, where each processor is responsible for a different function for a particular instance of network node 200). Similarly, network node 200 may be composed of multiple physically separate components (e.g., a NodeB component and a RNC component, a BTS component and a BSC component, etc.), which may each have their own respective processor, storage, and interface components. In certain scenarios in which network node 200 comprises multiple separate components (e.g., BTS and BSC components), one or more of the separate components may be shared among several network nodes. For example, a single RNC may control multiple NodeB's. In such a scenario, each unique NodeB and BSC pair, may be a separate network node. In some embodiments, network node 200 may be configured to support multiple radio access technologies (RATs). In such embodiments, some components may be duplicated (e.g., separate storage 203 for the different RATs) and some components may be reused (e.g., the same antenna 201a may be shared by the RATs).

Processor 202 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in conjunction with other network node 200 components, such as storage 203, network node 200 functionality. For example, processor 202 may execute instructions stored in storage 203. Such functionality may include providing various wireless features discussed herein to a wireless device, such as WD 210, including any of the features or benefits disclosed herein.

Storage 203 may comprise any form of volatile or non-volatile computer readable memory including, without limitation, persistent storage, solid state memory, remotely mounted memory, magnetic media, optical media, random access memory (RAM), read-only memory (ROM), removable media, or any other suitable local or remote memory component. Storage 203 may store any suitable instructions, data or information, including software and encoded logic, utilized by network node 200. Storage 203 may be used to store any calculations made by processor 202 and/or any data received via interface 201.

Network node 200 also comprises interface 201 which may be used in the wired or wireless communication of signalling and/or data between network node 200, network 220, and/or WD 210. For example, interface 201 may perform any formatting, coding, or translating that may be needed to allow network node 200 to send and receive data from network 220 over a wired connection. Interface 201 may also include a radio transmitter and/or receiver that may be coupled to or a part of antenna 201a. The radio may receive digital data that is to be sent out to other network nodes or WDs via a wireless connection. The radio may convert the digital data into a radio signal having the appropriate channel and bandwidth parameters. The radio signal may then be transmitted via antenna 201a to the appropriate recipient (e.g., WD 210).

Antenna 201a may be any type of antenna capable of transmitting and receiving data and/or signals wirelessly. In some embodiments, antenna 201a may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line.

As used herein, “wireless device” (WD) refers to a device capable, configured, arranged and/or operable to communicate wirelessly with network nodes and/or another wireless device. Communicating wirelessly may involve transmitting and/or receiving wireless signals using electromagnetic signals, radio waves, infrared signals, and/or other types of signals suitable for conveying information through air. In particular embodiments, wireless devices may be configured to transmit and/or receive information without direct human interaction. For instance, a wireless device may be designed to transmit information to a network on a predetermined schedule, when triggered by an internal or external event, or in response to requests from the network. Generally, a wireless device may represent any device capable of, configured for, arranged for, and/or operable for wireless communication, for example radio communication devices. Examples of wireless devices include, but are not limited to, user equipment (UE) such as smart phones. Further examples include wireless cameras, wireless-enabled tablet computers, laptop-embedded equipment (LEE), laptop-mounted equipment (LME), USB dongles, and/or wireless customer-premises equipment (CPE).

As one specific example, a wireless device may represent a UE configured for communication in accordance with one or more communication standards promulgated by the 3rd Generation Partnership Project (3GPP), such as 3GPP's GSM, UMTS, LTE, and/or 5G standards. As used herein, a “user equipment” or “UE” may not necessarily have a “user” in the sense of a human user who owns and/or operates the relevant device. Instead, a UE may represent a device that is intended for sale to, or operation by, a human user but that may not initially be associated with a specific human user.

The wireless device may support device-to-device (D2D) communication, for example by implementing a 3GPP standard for sidelink communication, and may in this case be referred to as a D2D communication device.

As yet another specific example, in an Internet of Things (JOT) scenario, a wireless device may represent a machine or other device that performs monitoring and/or measurements, and transmits the results of such monitoring and/or measurements to another wireless device and/or a network node. The wireless device may in this case be a machine-to-machine (M2M) device, which may in a 3GPP context be referred to as a machine-type communication (MTC) device. As one particular example, the wireless device may be a UE implementing the 3GPP narrow band internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a wireless device may represent a vehicle or other equipment that is capable of monitoring and/or reporting on its operational status or other functions associated with its operation.

A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As depicted in FIG. 24, WD 210 may be any type of wireless endpoint, mobile station, mobile phone, wireless local loop phone, smartphone, user equipment, desktop computer, PDA, cell phone, tablet, laptop, VoIP phone or handset, which is able to wirelessly send and receive data and/or signals to and from a network node, such as network node 200 and/or other WDs. WD 210 comprises processor 212, storage 213, interface 211, and antenna 211a.

Like network node 200, the components of WD 210 are depicted as single boxes located within a single larger box, however in practice a wireless device may comprises multiple different physical components that make up a single illustrated component (e.g., storage 213 may comprise multiple discrete microchips, each microchip representing a portion of the total storage capacity).

Processor 212 may be a combination of one or more of a microprocessor, controller, microcontroller, central processing unit, digital signal processor, application specific integrated circuit, field programmable gate array, or any other suitable computing device, resource, or combination of hardware, software and/or encoded logic operable to provide, either alone or in combination with other WD 210 components, such as storage 213, WD 210 functionality. Such functionality may include providing various wireless features discussed herein, including any of the features or benefits disclosed herein.

Storage 213 may be any form of volatile or non-volatile memory including, without limitation, persistent storage, solid state memory, remotely mounted memory, magnetic media, optical media, random access memory (RAM), read-only memory (ROM), removable media, or any other suitable local or remote memory component. Storage 213 may store any suitable data, instructions, or information, including software and encoded logic, utilized by WD 210. Storage 213 may be used to store any calculations made by processor 212 and/or any data received via interface 211.

Interface 211 may be used in the wireless communication of signalling and/or data between WD 210 and network node 200. For example, interface 211 may perform any formatting, coding, or translating that may be needed to allow WD 210 to send and receive data from network node 200 over a wireless connection. Interface 211 may also include a radio transmitter and/or receiver that may be coupled to or a part of antenna 211a. The radio may receive digital data that is to be sent out to network node 201 via a wireless connection. The radio may convert the digital data into a radio signal having the appropriate channel and bandwidth parameters. The radio signal may then be transmitted via antenna 211a to network node 200.

Antenna 211a may be any type of antenna capable of transmitting and receiving data and/or signals wirelessly. In some embodiments, antenna 211a may comprise one or more omni-directional, sector or panel antennas operable to transmit/receive radio signals between 2 GHz and 66 GHz. For simplicity, antenna 211a may be considered a part of interface 211 to the extent that a wireless signal is being used.

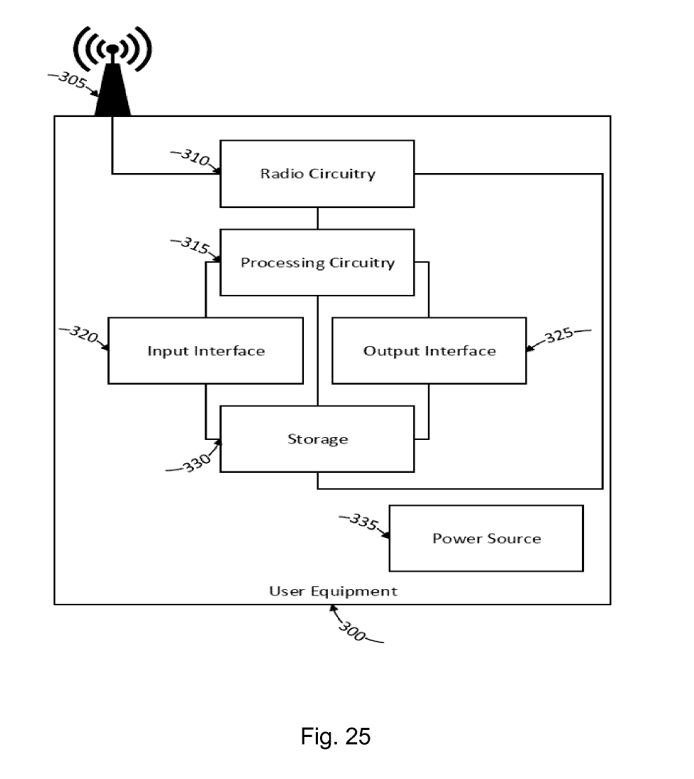

As shown in FIG. 25, user equipment 300 is an example wireless device. UE 330 includes an antenna 305, radio front-end circuitry 310, processing circuitry 315, and a computer-readable storage medium 330. Antenna 305 may include one or more antennas or antenna arrays, and is configured to send and/or receive wireless signals, and is connected to radio front-end circuitry 310. In certain alternative embodiments, wireless device 330 may not include antenna 305, and antenna 305 may instead be separate from wireless device 330 and be connectable to wireless device 330 through an interface or port.

The radio front-end circuitry 310 may comprise various filters and amplifiers, is connected to antenna 305 and processing circuitry 315, and is configured to condition signals communicated between antenna 305 and processing circuitry 315. In certain alternative embodiments, wireless device 330 may not include radio front-end circuitry 310, and processing circuitry 315 may instead be connected to antenna 305 without radio front-end circuitry 310.

Processing circuitry 315 may include one or more of radio frequency (RF) transceiver circuitry, baseband processing circuitry, and application processing circuitry. In some embodiments, the RF transceiver circuitry, baseband processing circuitry, and application processing circuitry may be on separate chipsets. In alternative embodiments, part or all of the baseband processing circuitry and application processing circuitry may be combined into one chipset, and the RF transceiver circuitry may be on a separate chipset. In still alternative embodiments, part or all of the RF transceiver circuitry and baseband processing circuitry may be on the same chipset, and the application processing circuitry may be on a separate chipset. In yet other alternative embodiments, part or all of the RF transceiver circuitry, baseband processing circuitry, and application processing circuitry may be combined in the same chipset. Processing circuitry 315 may include, for example, one or more central processing units (CPUs), one or more microprocessors, one or more application specific integrated circuits (ASICs), and/or one or more field programmable gate arrays (FPGAs).

In particular embodiments, some or all of the functionality described herein as being provided by a wireless device may be provided by the processing circuitry 315 executing instructions stored on a computer-readable storage medium 330. In alternative embodiments, some or all of the functionality may be provided by the processing circuitry 315 without executing instructions stored on a computer-readable medium, such as in a hard-wired manner. In any of those particular embodiments, whether executing instructions stored on a computer-readable storage medium or not, the processing circuitry can be said to be configured to perform the described functionality. The benefits provided by such functionality are not limited to the processing circuitry 315 alone or to other components of UE 300, but are enjoyed by the wireless device as a whole, and/or by end users and the wireless network generally.

Antenna 305, radio front-end circuitry 310, and/or processing circuitry 315 may be configured to perform any receiving operations described herein as being performed by a wireless device. Any information, data and/or signals may be received from a network node and/or another wireless device.

The processing circuitry 315 may be configured to perform any determining operations described herein as being performed by a wireless device. Determining as performed by processing circuitry 315 may include processing information obtained by the processing circuitry 315 by, for example, converting the obtained information into other information, comparing the obtained information or converted information to information stored in the wireless device, and/or performing one or more operations based on the obtained information or converted information, and as a result of said processing making a determination.

Antenna 305, radio front-end circuitry 310, and/or processing circuitry 315 may be configured to perform any transmitting operations described herein as being performed by a wireless device. Any information, data and/or signals may be transmitted to a network node and/or another wireless device.

Computer-readable storage medium 330 is generally operable to store instructions, such as a computer program, software, an application including one or more of logic, rules, code, tables, etc. and/or other instructions capable of being executed by a processor. Examples of computer-readable storage medium 330 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or any other volatile or non-volatile, non-transitory computer-readable and/or computer-executable memory devices that store information, data, and/or instructions that may be used by processing circuitry 315. In some embodiments, processing circuitry 315 and computer-readable storage medium 330 may be considered to be integrated.

Alternative embodiments of UE 330 may include additional components beyond those shown in Figure 3 that may be responsible for providing certain aspects of the UE's functionality, including any of the functionality described herein and/or any functionality necessary to support the solution described above. As just one example, UE 330 may include input interfaces, devices and circuits, and output interfaces, devices and circuits. Input interfaces, devices, and circuits are configured to allow input of information into UE 300, and are connected to processing circuitry 315 to allow processing circuitry 315 to process the input information. For example, input interfaces, devices, and circuits may include a microphone, a proximity or other sensor, keys/buttons, a touch display, one or more cameras, a USB port, or other input elements. Output interfaces, devices, and circuits are configured to allow output of information from UE 300, and are connected to processing circuitry 315 to allow processing circuitry 315 to output information from UE 300. For example, output interfaces, devices, or circuits may include a speaker, a display, vibrating circuitry, a USB port, a headphone interface, or other output elements. Using one or more input and output interfaces, devices, and circuits, UE 330 may communicate with end users and/or the wireless network, and allow them to benefit from the functionality described herein.

As another example, UE 330 may include power source 335. Power source 335 may comprise power management circuitry. Power source 335 may receive power from a power supply, which may either be comprised in, or be external to, power source 335. For example, UE 330 may comprise a power supply in the form of a battery or battery pack which is connected to, or integrated in, power source 335. Other types of power sources, such as photovoltaic devices, may also be used. As a further example, UE 330 may be connectable to an external power supply (such as an electricity outlet) via an input circuitry or interface such as an electrical cable, whereby the external power supply supplies power to power source 335. Power source 335 may be connected to radio front-end circuitry 310, processing circuitry 315, and/or computer-readable storage medium 330 and be configured to supply UE 300, including processing circuitry 315, with power for performing the functionality described herein.

UE 330 may also include multiple sets of processing circuitry 315, computer-readable storage medium 330, radio circuitry 310, and/or antenna 305 for different wireless technologies integrated into wireless device 300, such as, for example, GSM, WCDMA, LTE, NR, WiFi, or Bluetooth wireless technologies. These wireless technologies may be integrated into the same or different chipsets and other components within wireless device 300.

Any steps or features described herein are merely illustrative of certain embodiments. It is not required that all embodiments incorporate all the steps or features disclosed nor that the steps be performed in the exact order depicted or described herein. Furthermore, some embodiments may include steps or features not illustrated or described herein, including steps inherent to one or more of the steps disclosed herein.

Any appropriate steps, methods, or functions may be performed through a computer program product that may, for example, be executed by the components and equipment illustrated in one or more of the figures above. For example, storage 203 may comprise computer readable means on which a computer program can be stored. The computer program may include instructions which cause processor 202 (and any operatively coupled entities and devices, such as interface 201 and storage 203) to execute methods according to embodiments described herein. The computer program and/or computer program product may thus provide means for performing any steps herein disclosed.

Any appropriate steps, methods, or functions may be performed through one or more functional modules. Each functional module may comprise software, computer programs, sub-routines, libraries, source code, or any other form of executable instructions that are executed by, for example, a processor. In some embodiments, each functional module may be implemented in hardware and/or in software. For example, one or more or all functional modules may be implemented by processors 212 and/or 202, possibly in cooperation with storage 213 and/or 203. Processors 212 and/or 202 and storage 213 and/or 203 may thus be arranged to allow processors 212 and/or 202 to fetch instructions from storage 213 and/or 203 and execute the fetched instructions to allow the respective functional module to perform any steps or functions disclosed herein.

Certain aspects of the inventive concept have mainly been described above with reference to a few embodiments. However, as is readily appreciated by a person skilled in the art, embodiments other than the ones disclosed above are equally possible and within the scope of the inventive concept. Similarly, while a number of different combinations have been discussed, all possible combinations have not been disclosed. One skilled in the art would appreciate that other combinations exist and are within the scope of the inventive concept. Moreover, as is understood by the skilled person, the herein disclosed embodiments are as such applicable also to other standards and communication systems and any feature from a particular figure disclosed in connection with other features may be applicable to any other figure and or combined with different features.

Certain features and aspects have been described above with reference to a few embodiments. However, as is readily appreciated by a person skilled in the art, other embodiments than the ones disclosed above are equally possible within the scope of the invention.

Some embodiments described above may be summarized in the following manner:

1. A method for handover of a user equipment (UE), performed by a target control plane next generation (NG) core control function (NG CCF) operative in a core network, the method comprising:

receiving (110) a request; and

sending (111) an indication of a temporary user equipment (UE) identifier, a TA identity (TAI) list and/or an allowed area.

2. The method according to item 1, wherein:

the request is a forward relocation request from a source NG CCF; and

the sending (111) comprises sending a forward relocation response to the source NG CCF including the indication.

3. The method according to item 1 or 2, wherein the temporary UE identifier is a target global unique temporary identity (GUTI).

4. The method according to any one of items 1 to 3, further comprising receiving (112) a handover notify from a target radio access network (RAN), indicating that the temporary UE identifier is accepted by the UE.

5. The method according to item 4, wherein the handover notify includes an indication of tracking area update (TAU) complete.

6. The method according to item 1, wherein the temporary UE identifier is an indication of TAU accept (registration accept).

7. The method according to item 6, further comprising receiving a handover notify from a target radio access network including a TAU complete or registration complete.

8. The method according to item 7, further comprising sending (119) an update location to a subscriber data management (SDM).

9. A method for handover of a user equipment (UE), performed by a control plane next generation (NG) core control function (NG CCF) operative in a core network, the method comprising:

receiving (122) a path switch request from a radio access network (RAN); and

sending (123) a path switch request ack to the RAN, including a GUTI reallocation command message.

10. The method according to item 9, further comprising receiving (128) a GUTI reallocation complete message from an UE.

11. A method for handover of a user equipment (UE), performed by a radio access network (RAN) operative in a network, the method comprising:

receiving (124) a path switch request ack from a NG CCF; and

sending (125) a DL information transfer to the UE, including a GUTI reallocation command.

12. A method for handover of a user equipment (UE), performed by the UE operative in a network, the method comprising:

receiving (126) a DL information transfer from a target RAN; and

sending (127) a GUTI reallocation complete to a NG CCF.

13. A method for handover of a user equipment (UE), performed by the UE, the method comprising:

receiving (120) a handover command including a temporary user equipment (UE) identifier, a TA, a TA identity (TAI) list and/or an allowed area; and

sending (121) a handover confirmation.

14. The method according to item 13, wherein the handover command is received from a source radio access network (RAN), and the handover confirmation is sent to a target RAN.

15. The method according to item 13 or 14, wherein the handover command includes a target global unique temporary identity (GUTI) and/or a new TA and/or a TAI-list and/or a new allowed area.

16. The method according to any one of items 13 to 15, further comprising replacing a current temporary user equipment (UE) identifier, TA, TA identity (TAI) list and/or allowed area with a received corresponding one.

17. The method according to item 13 or 14, wherein the handover confirmation includes an indication of tracking area update (TAU) complete.

18. A method for handover of a user equipment (UE), performed by a source control plane next generation (NG) core control function (NG CCF) operative in a core network, the method comprising:

receiving (113) a target global unique temporary identity (GUTI), a TA identity (TAI) list and/or an allowed area from a target NG CCF; and sending (114) a handover command including the target GUTI, a TA, a TA identity (TAI) list and/or an allowed area to a source radio access network (RAN).

19. A method for handover of a user equipment (UE), performed by a source radio access node (RAN) operative in a network, the method comprising:

receiving (117) a handover command including a target global unique temporary identity (GUTI), a TA, a TA identity (TAI) list and/or an allowed area from a source control plane next generation (NG) core control function (NG CCF); and

sending (118) a handover command including the target GUTI, a TA, a TA identity (TAI) list and/or an allowed area to a UE.

20. A method for handover of a user equipment (UE), performed by a target radio node operative in a network, the method comprising:

receiving (115) a handover confirm including an indication of tracking area update (TAU) complete from a UE; and

sending (116) a handover notify including the indication of TAU complete to a target control plane next generation (NG) core control function (NG CCF).

21. A target control plane next generation (NG) core control function (NG CCF) operative in a core network for handover of a user equipment (UE), the NG CCF comprising:

a processor (10); and

a computer program product (12, 13) storing instructions that, when executed by the processor, causes the target NG CCF to:

receive (110) a forward relocation request from a source NG CCF; and

send (111) a forward relocation response to the source NG CCF, indicating a temporary user equipment (UE) identifier, a TA identity (TAI) list and/or an allowed area.

22. The NG CCF according to item 21, wherein the temporary UE identifier is a target global unique temporary identity (GUTI).

23. The NG CCF according to any one of items 21 to 22, further caused to receive (112) a handover notify from a target radio access network (RAN), indicating that the temporary UE identifier is accepted by the UE.

24. The NG CCF according to item 23, wherein the handover notify includes an indication of tracking area update (TAU) complete.

25. The NG CCF according to item 24, wherein the temporary UE identifier is an indication of TAU accept (registration accept).

26. The NG CCF according to item 25, further caused to receive a handover notify from a target radio access network including a TAU complete or registration complete.

27. The NG CCF according to item 26, further caused to send an update location to a subscriber data management (SDM).

28. A control plane next generation (NG) core control function (NG CCF) operative in a core network for handover of a user equipment (UE), the NG CCF comprising:

a processor (10); and

a computer program product (12, 13) storing instructions that, when executed by the processor, causes the NG CCF to:

receive a path switch request from a target radio access network (RAN); and

send a path switch request ack to the target RAN, including the temporary UE identifier, a TA, a TA identity (TAI) list and/or an allowed area.

29. The NG CCF according to item 28, further cause to receive a GUTI reallocation complete message from an UE.

30. A target radio access network (RAN) operative in a network for handover of a user equipment (UE), the target RAN comprising:

a processor (10); and

a computer program product (12, 13) storing instructions that, when executed by the processor, causes the target RAN to:

receive a path switch request ack from a NG CCF; and

send a DL information transfer to the UE, including a GUTI reallocation command, a TA, a TA identity (TAI) list and/or an allowed area.

31. A user equipment (UE) for handover thereof, the UE comprising:

a processor (10); and

a computer program product (12, 13) storing instructions that, when executed by the processor, causes the UE to:

receive a DL information transfer from a target RAN; and

send a GUTI reallocation complete to a NG CCF.

32. A UE for handover thereof, the UE comprising:

a processor (10); and

a computer program product (12, 13) storing instructions that, when executed by the processor, causes the UE to:

receive (120) a handover command including a temporary user equipment (UE) identifier, a TA identity (TAI) list and/or an allowed area; and

send (121) a handover confirmation.

33. The UE according to item 32, wherein the handover command is received from a source radio access network (RAN), and the handover confirmation is sent to a target RAN.

34. The UE according to item 32 or 33, wherein the temporary UE identifier is included in a target global unique temporary identity (GUTI) message.

35. The UE according to item 33 or 34, wherein the handover confirmation includes an indication of tracking area update (TAU) complete.

36. A source control plane next generation (NG) core control function (NG CCF) operative in a core network for handover of a user equipment (UE), the source NG CCF comprising:

a processor (10); and

a computer program product (12, 13) storing instructions that, when executed by the processor, causes the source NG CCF to:

receive a target global unique temporary identity (GUTI), a TA identity (TAI) list and/or an allowed area from a target NG CCF; and

send a handover command including the target GUTI, a TA, a TA identity (TAI) list and/or an allowed area to a source radio access node (RAN).

37. A source radio access network (RAN) operative in a network for handover of a user equipment (UE), the source RAN comprising:

a processor (10); and

a computer program product (12, 13) storing instructions that, when executed by the processor, causes the source RAN to:

receive a handover command including a target global unique temporary identity (GUTI) , a TA, a TA identity (TAI) list and/or an allowed area from a source control plane next generation (NG) core control function (NG CCF); and

send a handover command including the target GUTI to a UE.

38. A target radio access network (RAN) operative in a network for handover of a user equipment (UE), the target RAN comprising:

a processor (10); and

a computer program product (12, 13) storing instructions that, when executed by the processor, causes the target RAN to:

receive a handover confirm including an indication of tracking area update (TAU) complete from a UE; and

send a handover notify including the indication of TAU complete to a target control plane next generation (NG) core control function (NG CCF).

39. A target control plane next generation (NG) core control function (NG CCF) operative in a core network for handover of a user equipment (UE), the target NG CCF comprising:

a communication manager (60) for receiving (110) a forward relocation request from a source NG CCF, and for sending (iii) a forward relocation response to the source NG CCF, indicating a temporary user equipment (UE) identifier, a TA identity (TAI) list and/or an allowed area.

40. A control plane next generation (NG) core control function (NG CCF) operative in a core network for handover of a user equipment (UE), the NG CCF comprising:

a communication manager (60) for receiving (122) a path switch request from a target radio access network (RAN), and for sending (123) a path switch request ack to the target RAN, including a GUTI reallocation command message.

41. A radio access network (RAN) operative in a network for handover of a user equipment (UE), the RAN comprising:

a communication manager (60) for receiving (124) a path switch request ack from a NG CCF, and sending (125) a DL information transfer to the UE, including a GUTI reallocation command, a TA, a TA identity (TAI) list and/or an allowed area.

42. A user equipment (UE) for handover thereof, the UE comprising:

a communication manager (60) for receiving (126) a DL information transfer from a target RAN, and sending (127) a GUTI reallocation complete to a NG CCF.

43. A user equipment (UE) for handover thereof, the UE comprising:

a communication manager (60) for receiving (120) a handover command including a temporary user equipment (UE) identifier, a TA, a TA identity (TAI) list and/or an allowed area, and for sending (121) a handover confirmation.

44. A source control plane next generation (NG) core control function (NG CCF) operative in a core network for handover of a user equipment (UE), the source NG CCF comprising:

a communication manager (60) for receiving (113) a target global unique temporary identity (GUTI), a TA identity (TAI) list and/or an allowed area from a target NG CCF, and for sending (114) a handover command including the target GUTI, a TA, a TA identity (TAI) list and/or an allowed area to a source radio access node (RAN).

45. A source radio access network (RAN) operative in a network for handover of a user equipment (UE), the source RAN comprising:

a communication manager (60) for receiving (117) a handover command including a target global unique temporary identity (GUTI), a TA, a TA identity (TAI) list and/or an allowed area from a source control plane next generation (NG) core control function (NG CCF), and for sending (118) a handover command including the target GUTI to a UE.

46. A target radio access node (RAN) operative in a network for handover of a user equipment (UE), the target RAN comprising:

a communication manager (60) for receiving (115) a handover confirm including an indication of tracking area update (TAU) complete from a UE, and for sending (116) a handover notify including the indication of TAU complete to a target control plane next generation (NG) core control function (NG CCF).

47. A computer program (14, 15) for handover of a user equipment (UE), the computer program comprising computer program code which, when run on a target control plane next generation (NG) core control function (NG CCF) operative in a core network, causes the target NG CCF to:

receive (110) a forward relocation request from a source NG CCF; and

send (111) a forward relocation response to the source NG CCF, indicating a temporary user equipment (UE) identifier, a TA identity (TAI) list and/or an allowed area.

48. A computer program (14, 15) for handover of a user equipment (UE), the computer program comprising computer program code which, when run on a control plane next generation (NG) core control function (NG CCF) operative in a core network, causes the NG CCF to:

receive (122) a path switch request from a target radio access network (RAN); and

send (123) a path switch request ack to the target RAN, including a GUTI reallocation command message.

49. A computer program (14, 15) for handover of a user equipment (UE), the computer program comprising computer program code which, when run on a target radio access network (RAN) operative in a network, causes the target RAN to:

receive (124) a path switch request ack from a NG CCF; and

send (125) a DL information transfer to the UE, including a GUTI reallocation command.

50. A computer program (14, 15) for handover of a user equipment (UE), the computer program comprising computer program code which, when run on the UE, causes the UE to:

receive (126) a DL information transfer from a target RAN; and

send (127) a GUTI reallocation complete to a NG CCF.

51. A computer program (14, 15) for handover of a user equipment (UE), the computer program comprising computer program code which, when run on the UE, causes the UE to:

receive (120) a handover command including a temporary user equipment (UE) identifier, a TA, a TA identity (TAI) list and/or an allowed area; and

send (121) a handover confirmation.

52. A computer program (14, 15) for handover of a user equipment (UE), the computer program comprising computer program code which, when run on a source control plane next generation (NG) core control function (NG CCF) operative in a core network, causes the source NG CFF to:

receive (113) a target global unique temporary identity (GUTI), a TA identity (TAI) list and/or an allowed area from a target NG CCF; and

send (114) a handover command including the target GUTI, a TA, a TA identity (TAI) list and/or an allowed area to a source radio access node (RAN).

53. A computer program (14, 15) for handover of a user equipment (UE), the computer program comprising computer program code which, when run on a source radio access network (RAN) operative in a network, causes the source RAN to:

receive (117) a handover command including a target global unique temporary identity (GUTI), a TA, a TA identity (TAI) list and/or an allowed area from a source control plane next generation (NG) core control function (NG CCF); and

send (118) a handover command including the target GUTI, a TA, a TA identity (TAI) list and/or an allowed area to a UE.

54. A computer program (14, 15) for handover of a user equipment (UE), the computer program comprising computer program code which, when run on a target radio access network (RAN) operative in a network, causes the target RAN to:

receive (115) a handover confirm including an indication of tracking area update (TAU) complete from a UE; and

send (116) a handover notify including the indication of TAU complete to a target control plane next generation (NG) core control function (NG CCF).

55. A computer program product (12, 13) comprising a computer program (14, 15) according to any one of items 45 to 52 and a computer readable storage means on which the computer program (14, 15) is stored.

### LIST OF ACRONYMS

CHF Control Handling Function (a part of NG Core Control)

CHF-C Control Handling Function Control Plane (a part of CHF)

CHF-U Control Handling Function User Plane (a part of CHF)

eNB E-UTRAN NodeB

FWA Fixed Wireless Access

HRL Handover Restriction list

IoT Internet of Things

LTE Long Term Evolution (a 4G mobile network)

MBB Mobile Broadband

MME Mobility Management Entity

NG Next Generation mobile network i.e. 5G

NG PC Next Generation Policy Control

OTA Over The Air

RAT Radio Access Technology

Si interface between eNB and MME/S-GW

SDM Subscriber Data Management

S-GW Serving Gateway

TA Tracking Area

TAU Tracking Area Update

THF Traffic Handling Function (a part of NG Core Control)

X2 interface between eNBs.

1. A method for handover of a user equipment (UE), performed by a target control plane next generation (NG) core control function (NG CCF) operative in a core network, the method comprising:
receiving a request; and
sending an indication of a temporary UE identifier, a Tracking Area identity (TAI) list and/or an allowed area.

2. The method according to claim 1, wherein:
the request is a forward relocation request from a source NG CCF; and
the sending comprises sending a forward relocation response to the source NG CCF including the indication.

3. The method according to claim 1, wherein the temporary UE identifier is a target global unique temporary identity (GUTI).

4. The method according to claim 1, further comprising receiving a handover notify from a target radio access network (RAN), indicating that the temporary UE identifier is accepted by the UE.

5. The method according to claim 4, wherein the handover notify includes an indication of tracking area update (TAU) complete.

6. The method according to claim 1, wherein the temporary UE identifier is an indication of TAU accept (registration accept).

7. The method according to claim 6, further comprising receiving a handover notify from a target radio access network including a TAU complete or registration complete.

8. The method according to claim 7, further comprising sending an update location to a subscriber data management (SDM).

9. A method for handover of a user equipment (UE), performed by a control plane next generation (NG) core control function (NG CCF) operative in a core network, the method comprising:
receiving a path switch request from a radio access network (RAN); and
sending a path switch request acknowledgement to the RAN, including a Global Unique Temporary Identity (GUTI) reallocation command message.

10. The method according to claim 9, further comprising receiving a GUTI reallocation complete message from an UE.

11. A method for handover of a user equipment (UE), performed by the UE, the method comprising:
receiving a handover command including a temporary UE identifier, a Tracking Area (TA), a TA identity (TAI) list and/or an allowed area; and
sending a handover confirmation.

12. The method according to claim 11, wherein the handover command is received from a source radio access network (RAN), and the handover confirmation is sent to a target RAN.

13. The method according to claim 11, wherein the handover command includes a target global unique temporary identity (GUTI) and/or a new TA and/or a TAI-list and/or a new allowed area.

14. The method according to claim 11, further comprising replacing a current temporary UE identifier, TA, TAI list and/or allowed area with a received corresponding one.

15. The method according to claim 11, wherein the handover confirmation includes an indication of tracking area update (TAU) complete.

16. A method for handover of a user equipment (UE), performed by a source control plane next generation (NG) core control function (NG CCF) operative in a core network, the method comprising:
receiving a target global unique temporary identity (GUTI), a Tracking Area identity (TAI) list and/or an allowed area from a target NG CCF; and
sending a handover command including the target GUTI, a Tracking Area (TA), a TAI list and/or an allowed area to a source radio access network (RAN).

17. A method for handover of a user equipment (UE), performed by a source radio access node (RAN) operative in a network, the method comprising:
receiving a handover command including a target global unique temporary identity (GUTI), a Tracking Area (TA), a TA identity (TAI) list and/or an allowed area from a source control plane next generation (NG) core control function (NG CCF); and
sending a handover command including the target GUTI, a TA, TAI list and/or an allowed area to a UE.

18. A method for handover of a user equipment (UE), performed by a target radio node operative in a network, the method comprising:
receiving a handover confirm including an indication of tracking area update (TAU) complete from a UE; and
sending a handover notify including the indication of TAU complete to a target control plane next generation (NG) core control function (NG CCF).
